(19) United States
(12) Patent Application Publication
(10) Pub. No.: US 2012/0187214 A1
(43) Pub. Date: Jul. 26, 2012

(54) CONVERGING BLOCKER DOOR SYSTEM FOR USE WITH A THRUST REVERSER

(75) Inventors: John Michael Welch, Wichita, KS (US); Christopher Steven Sawyer, Udall, KS (US)

(73) Assignee: Spirit AeroSystems, Inc., Wichita, KS (US)

(21) Appl. No.: 13/013,053

(22) Filed: Jan. 25, 2011

(51) Int. Cl. B64D 33/00

(52) U.S. Cl. 239/265.19

(57) ABSTRACT

A blocker door system to be used with an aircraft engine thrust reverser comprises a push ring, a plurality of connecting rods, a plurality of crankshafts, a plurality of blocker doors, and a plurality of linking elements. The push ring may encircle the aircraft engine. The connecting rods may connect along the circumference of the push ring. The crankshafts may rotatably couple to the connecting rods. The blocker doors may be positioned adjacent one another around the circumference of the aircraft engine wherein at least a portion of one blocker door covers at least a portion of the adjacent blocker door. The linking elements may connect one blocker door to the adjacent blocker door and may be operable to guide the motion of the blocker doors relative to one another.

### BACKGROUND OF THE INVENTION

1. Field of the Invention

Embodiments of the present invention relate to aircraft engine thrust reversers. More particularly, embodiments of the present invention relate to blocker doors for use with cascade-type aircraft engine thrust reversers.

2. Description of the Related Art

Cascade thrust reversers are often employed in aircraft under-wing bypass-type engines and may include blocker doors located along the outer circumferential wall of the bypass fan duct, such that when the thrust reverser is deployed, the blocker doors are actuated inward to redirect the flow of air in the bypass fan duct to flow through the cascades—thereby providing reverse thrust. The blocker doors often have an isosceles trapezoid shape with a broad base, a narrower top, and two angled sides. The doors, when stowed, are typically positioned in line with the outer wall of the fan duct, such that the base is pointed in the forward direction and the top is pointed in the aft direction. When the blocker doors are pulled inward during deployment, the sides of one door nearly contact the sides of adjacent doors to effectively seal off the fan duct. However, gaps form between the sides of the blocker doors which allows some air to pass through the blocker doors. Thus, optimal reverse thrust may not be achieved with conventional thrust reverser blocker doors.

Additionally, traditional blocker doors are pulled into deployment by drag links anchored to the inner fixed structure, and require a substantial stroke length to provide a kinematic solution that will not bind during deployment, and to translate a diaphragm housing the blocker doors out of the way so that airflow may reach the cascades.

### SUMMARY OF THE INVENTION

Embodiments of the present invention solve the above-mentioned problems and provide a distinct advance in the art of aircraft engine thrust reversers.

More particularly, embodiments of the invention provide blocker doors for use with cascade-type aircraft engine thrust reversers that converge together during deployment of the thrust reverser.

Embodiments of the present invention provide a blocker door system for use with an aircraft engine thrust reverser that includes a plurality of cascade elements. The system may broadly comprise a push ring, a plurality of connecting rods, a plurality of crankshafts, a plurality of blocker doors, and a plurality of linking elements. The push ring may encircle the aircraft engine. The connecting rods may connect along the circumference of the push ring. The crankshafts may rotatably couple to the connecting rods and the blocker doors. The linking elements may connect one blocker door to the adjacent blocker door and may be operable to guide the motion of the blocker doors relative to one another.

Each blocker door may also include a first side, a second side, a top edge, and a bottom edge. Both the top edge and the bottom edge may possess a curvature, and the top edge may be shorter in length than the bottom edge. The first side may extend between the top edge and the bottom edge and may include a first mating feature. The second side may be spaced apart from the first side and may include a second mating feature that is complementary to the first mating feature such that the first mating feature integrates with the second mating feature.

The blocker doors may be positioned adjacent one another around the circumference of the aircraft engine wherein at least a portion of one blocker door covers at least a portion of the adjacent blocker door. The blocker doors may also be operable to occupy a first position when the thrust reverser is stowed and to converge together to a second position when the thrust reverser is deployed to provide maximum airflow to the cascade elements.

The mating features of the converging blocker door system allow the quick deployment of the doors over a substantially shorter stroke than conventional blocker door-diaphragm/translating sleeve systems with traditional drag links anchored to a fixed inner structure. The absence of a translating diaphragm in this concept combined with the placement of the cascades further outboard from the engine centerline creates the opportunity for a substantially shortened stroke length and less weight of the translating elements at equivalent or better reverser efficiencies. It can also be appreciated that the absence of drag links in the fan duct flow would further improve engine performance.

This summary is provided to introduce a selection of concepts in a simplified form that are further described below in the detailed description. This summary is not intended to identify key features or essential features of the claimed subject matter, nor is it intended to be used to limit the scope of the claimed subject matter.

Other aspects and advantages of the present invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is a side view of an aircraft wing with a bypass-type engine with certain hidden components shown in dashed lines;

FIG. 2 is a perspective view looking aftward at a portion of the engine that includes a fan duct and a blocker door system constructed in accordance with various embodiments of the current invention;

FIG. 3 is a front view of the fan duct and the blocker door system;

FIG. 4 is a sectional view cut along line 4-4 of FIG. 3 depicting a portion of the blocker door system with the thrust reverser in the stowed position;

FIG. 5 is a sectional view cut along line 5-5 of FIG. 8 depicting a portion of the blocker door system with the thrust reverser in the deployed position;

FIG. 6 is a top view of the engine during deployment of a thrust reverser depicting an outer cowl shroud translated aftward exposing a plurality of cascade elements;

FIG. 7 is a perspective view looking aftward at the fan duct and the blocker door system during deployment of the thrust reverser depicting a plurality of a first embodiment of blocker doors in a deployed position;

FIG. 8 is a front view of the fan duct and the blocker door system during deployment of the thrust reverser depicting the first embodiment of the blocker doors in the deployed position;

FIG. 9 is a perspective view of the first embodiment of the blocker doors in isolation;

FIG. 10 is a top view of the first embodiment of the blocker doors in isolation;

FIG. 11 is a sectional view cut along line 11-11 of FIG. 10 of a first embodiment of a linking element of the blocker doors;

FIG. 12 is a perspective view looking aftward at the fan duct and the blocker door system during deployment of the thrust reverser depicting a plurality of a second embodiment of blocker doors in a deployed position;

FIG. 13 is a front view of the fan duct and the blocker door system during deployment of the thrust reverser depicting the second embodiment of the blocker doors in the deployed position;

FIG. 14 is a perspective view of the second embodiment of the blocker doors in isolation;

FIG. 15 is a top view of the second embodiment of the blocker doors in isolation;

FIG. 16 is a sectional view cut along line 16-16 of FIG. 15 of a second embodiment of a linking element of the blocker doors;

FIG. 17 is a perspective view looking aftward at the fan duct and the blocker door system during deployment of the thrust reverser depicting a plurality of a third embodiment of blocker doors in a deployed position;

FIG. 18 is a front view of the fan duct and the blocker door system during deployment of the thrust reverser depicting the third embodiment of the blocker doors in the deployed position;

FIG. 19 is a perspective view of the third embodiment of the blocker doors in isolation;

FIG. 20 is a top view of the third embodiment of the blocker doors in isolation;

FIG. 21 is a perspective view looking aftward at the fan duct and the blocker door system during deployment of the thrust reverser depicting a plurality of a fourth embodiment of blocker doors in a deployed position;

FIG. 22 is a front view of the fan duct and the blocker door system during deployment of the thrust reverser depicting the fourth embodiment of the blocker doors in the deployed position;

FIG. 23 is a perspective view of the fourth embodiment of the blocker doors in isolation;

FIG. 24 is a perspective view of a first door of the fourth embodiment of the blocker doors in isolation; and

FIG. 25 is a perspective view of a second door of the fourth embodiment of the blocker doors in isolation.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

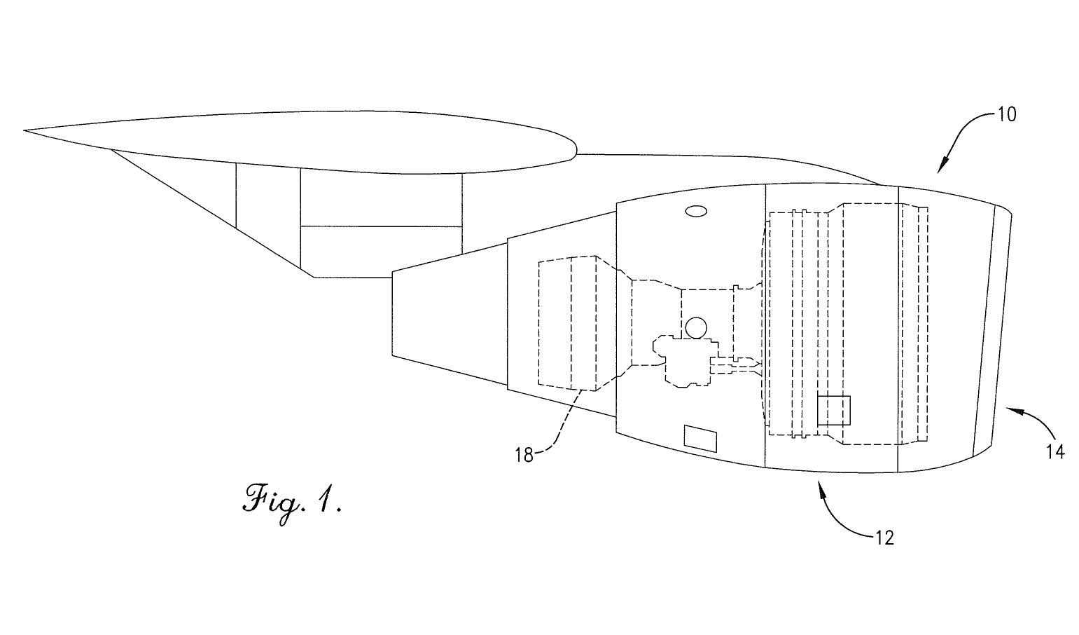

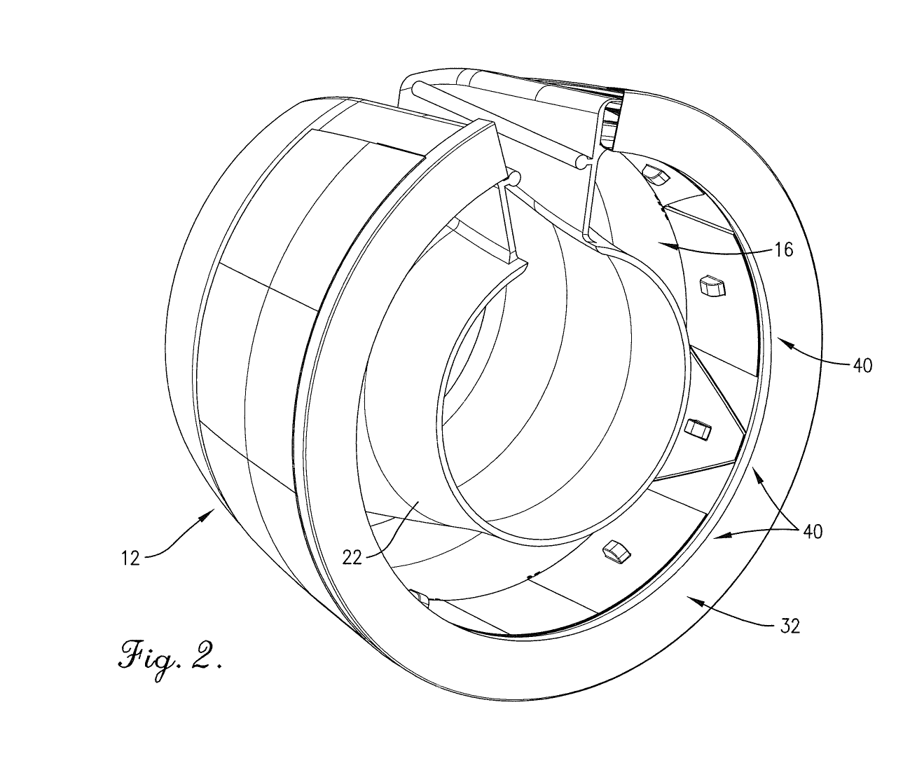

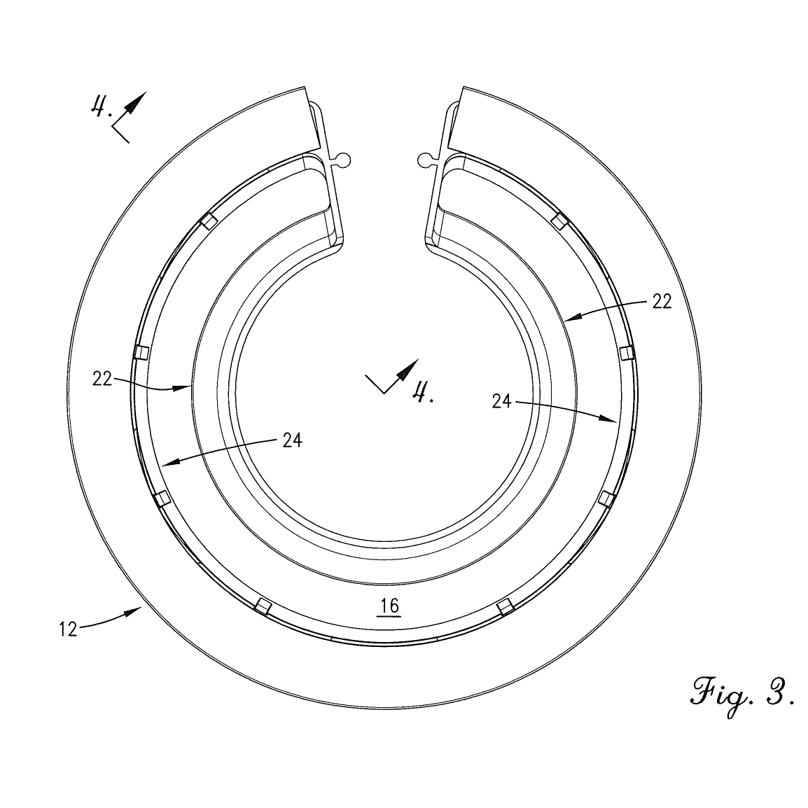

An aircraft under-wing bypass-type engine 10 is shown in FIG. 1. The bypass engine 10 may include a nacelle 12, an air inlet 14, a fan duct 16, a turbine element 18, and a cascade thrust reverser 20. The nacelle 12 may be roughly barrel shaped and may form the outer shell of the engine 10. The inlet 14 may include an opening positioned at the front of the nacelle 12. The fan duct 16, as best seen in FIGS. 2-5, may include an air passageway between an inner wall 22 adjacent to the turbine element 18 and an opposing outer wall 24 adjacent the nacelle 12. The fan duct 16 may be a 350-degree monolithic fan duct, as disclosed in U.S. patent application Ser. No. 12/365,376 filed on Feb. 4, 2009, and incorporated by reference herein in its entirety. The turbine element 18, shown in outline in FIG. 1, may provide at least a portion of the thrust of the engine 10 and may be positioned along the central longitudinal axis of the engine 10.

The terms “outward” and “inward” are used throughout the specification, wherein outward generally refers to a direction away from the center of the engine 10, and inward generally refers to a direction toward the center of the engine 10.

Generally, the bypass engine 10 takes in air through the air inlet 14. The intake air may be split into a first airflow that flows through the turbine element 18 and a second airflow that bypasses the turbine element 18 and flows through the fan duct 16. The second airflow may be redirected through the cascade thrust reverser 20, during deployment, to provide reverse thrust for the aircraft.

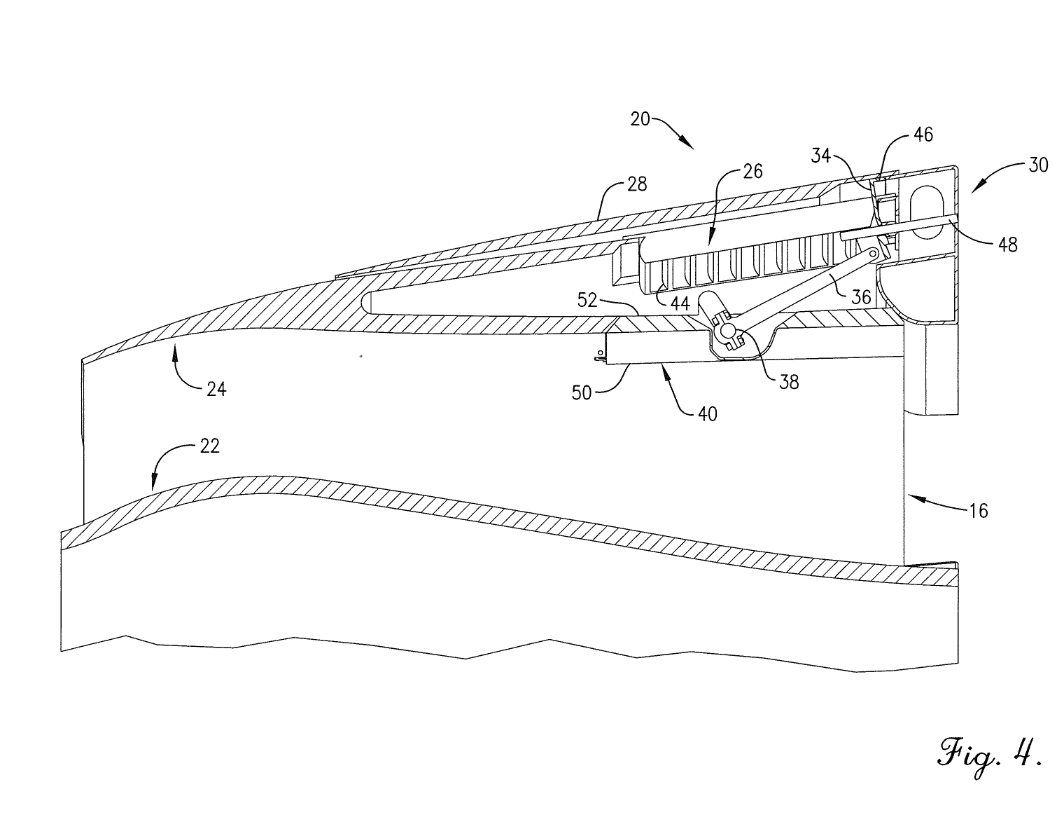

The cascade thrust reverser 20, seen at least in part in FIGS. 4-6, may include a plurality of cascade elements 26, an outer cowl shroud 28, a plurality of actuating units 30, and a blocker door system 32 constructed in accordance with various embodiments of the present invention. The blocker door system 32 may broadly comprise a push ring 34, a plurality of connecting rods 36, a plurality of crankshafts 38, a plurality of blocker doors 40, and a plurality of linking elements 42.

The cascade elements 26, shown in FIGS. 4-6, may include an array of arcuate vanes 44 that possess a curvature such that the outer edges of the vanes 44 are pointing generally forward. The cascade elements 26 may be positioned adjacent one another to form a band along the circumference of the engine 10. In other embodiments, there may be a single elongated cascade element located along the circumference of the engine 10. The cascade elements 26 may be covered by the outer cowl shroud 28 when the thrust reverser 20 is stowed. During deployment of the thrust reverser 20, the cascade elements 26 generally direct airflow, exhaust gases, or a combination thereof in a forward direction relative to the engine 10.

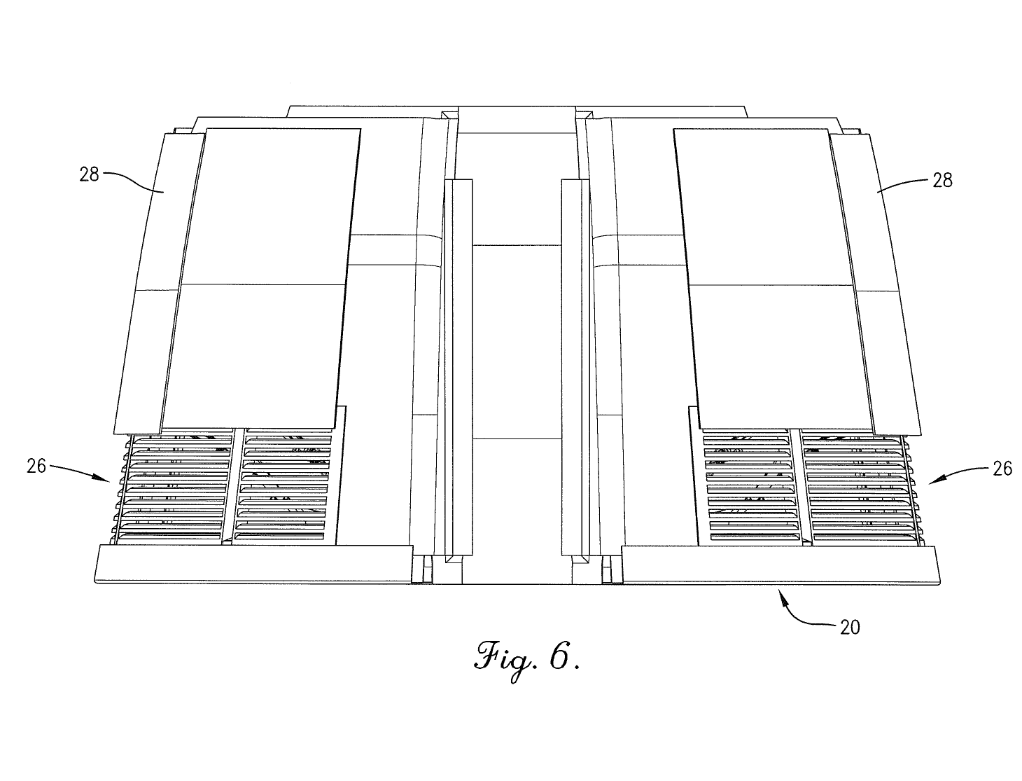

The outer cowl shroud 28 may include an aft section of the nacelle 12 which is separable from the forward section of the nacelle 12 and may be operable to translate linearly along the longitudinal axis of the engine 10, as seen in FIG. 6. The outer cowl shroud 28 may further include at least one shroud attach fitting 46 that couples with the actuating units 30. When the thrust reverser 20 is stowed, the outer cowl shroud 28 may be positioned forwardly, such that at least a portion of the outer cowl shroud 28 is covering the cascade elements 26. When the thrust reverser 20 is deployed, the outer cowl shroud 28 may move aftward to expose the cascade elements 26 and allow an airflow path through the cascade elements 26.

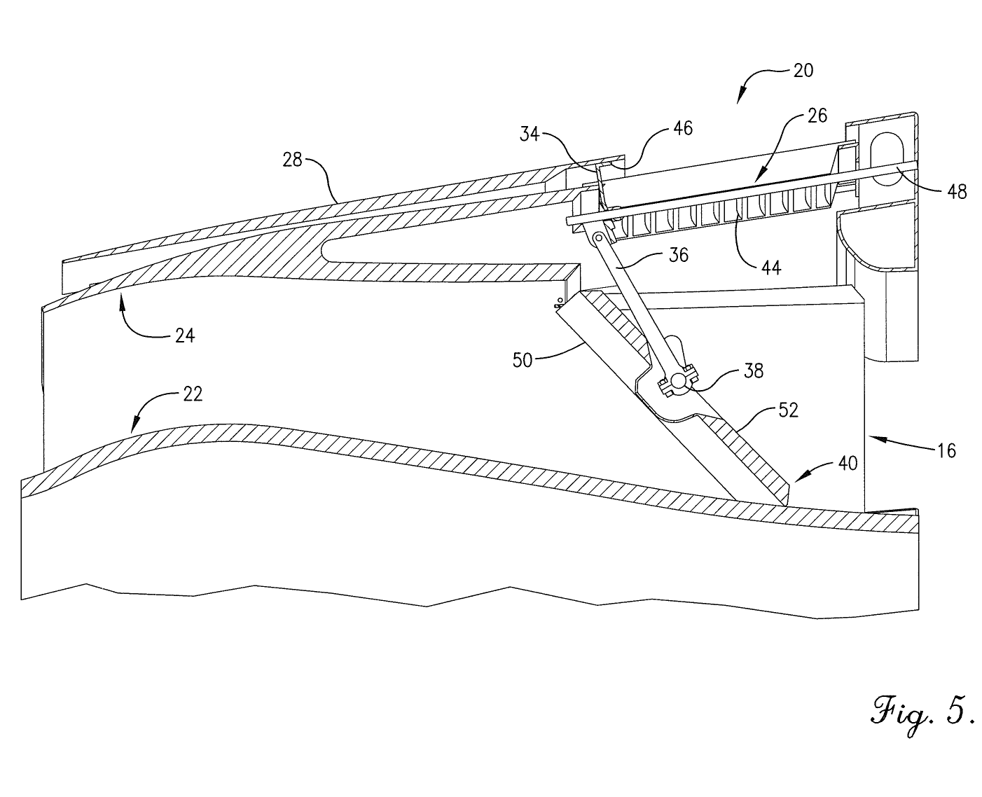

The actuating units 30 may include an actuator (not shown in the figures) and an actuator arm 48, seen in FIGS. 4-5. There may be at least four actuating units 30 located around the circumference of the engine 10. With each actuating unit 30, the actuator may be positioned forward of the cascade elements 26 and may be powered electrically, hydraulically, or the like. The actuator arm 48 may be coupled to an output of the actuator and may extend aftward to couple with the push ring 34 and the shroud attach fitting 46. During deployment of the thrust reverser 20, the actuator may push the actuator arm 48 rearward, in turn translating the shroud attach fittings 46 along with the outer cowl shroud 28 and the push ring 34 rearward.

The push ring 34 may include a circular shaped strip of high strength material such as metal, and may be positioned around the circumference of the engine 10 inward from the cascade elements 26. The push ring 34 may be attached to the aft end of the actuator arm 48 and may further couple to the connecting rods 36 and the shroud attach fittings 46.

The connecting rods 36 are generally elongated, each with a first end and a second end, as seen in FIGS. 4-5. The first end may be rotatably coupled with one of the actuator arms 48 such that the rotation is in the direction of the longitudinal axis of the engine 10. The connecting rod 36 may rotate inward during deployment of the thrust reverser 20 and outward after deployment. The second end of each connecting rod 36 may be rotatably coupled to one of the crankshafts 38, each of which may be rotatably connected to a blocker door 40. Thus, the second end of the connecting rod 36 may rotate offset from the rotation of the crankshaft 38 with the blocker doors 40.

The blocker doors 40 may each have an inner surface 50 and a spaced-apart outer surface 52. Each blocker door 40 may also include a first side 54, a second side 56, a top edge 58, and a bottom edge 60. The first side 54 and the second side 56 connect the top edge 58 to the bottom edge 60. In some embodiments, the top edge 58 may be slightly shorter in length than the bottom edge 60. Thus, the first side 54 and the second side 56 are sloped outward from the top edge 58 to the bottom edge 60. Furthermore, each blocker door 40 may have a curvature across the inner surface 50 and the outer surface 52 that generally matches the curvature of the outer wall 24 of the fan duct 16. The curvature helps to create a smoother surface along the outer wall 24 when the thrust reverser 20 is stowed.

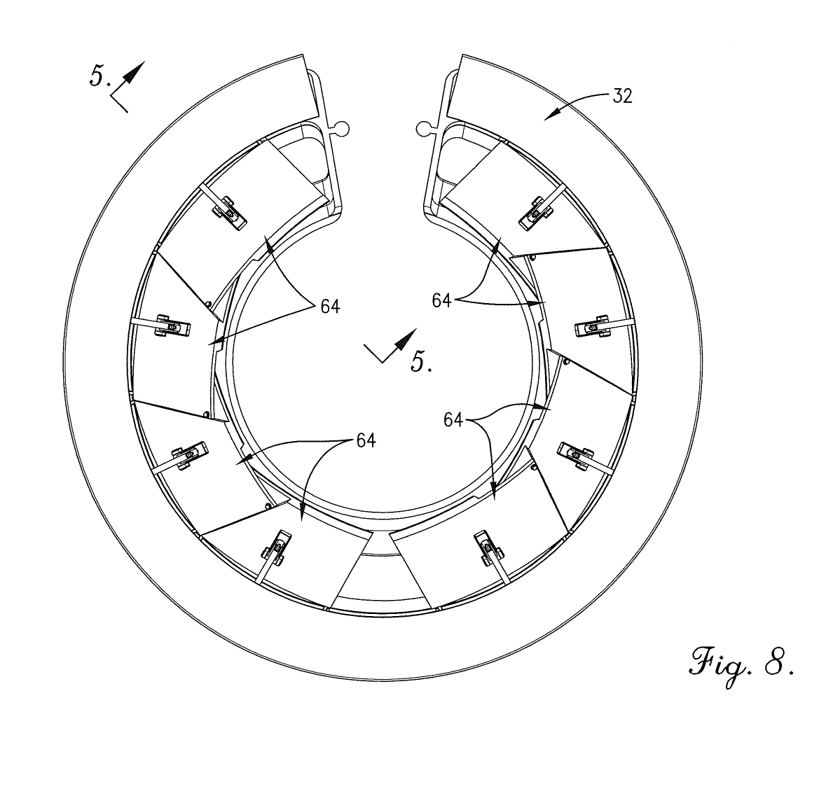

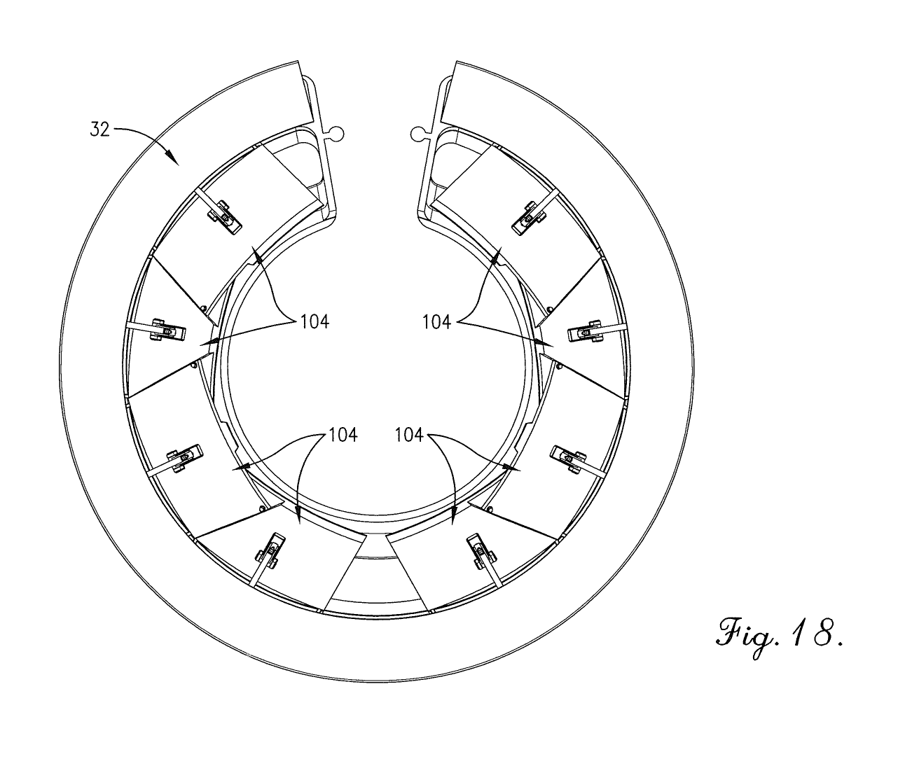

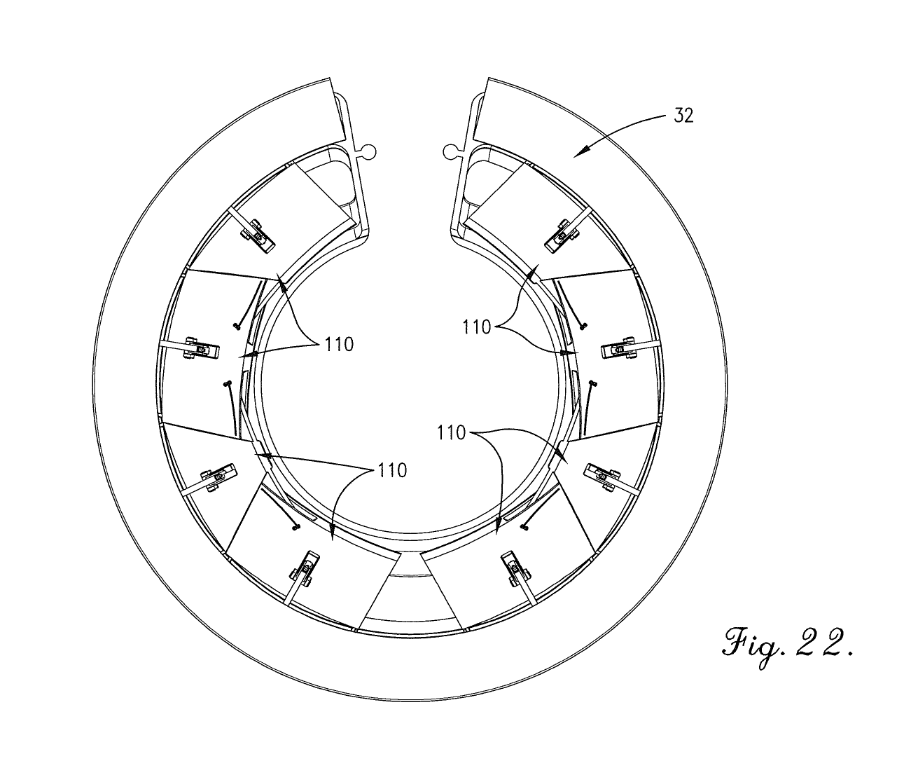

The blocker doors 40 may be positioned adjacent one another around the circumference of the outer wall 24 of the fan duct 16. In various embodiments, there may be four blocker doors 40 positioned adjacent one another on the left half of the engine 10 and four blocker doors 40 positioned adjacent one another on the right half of the engine 10, as seen in FIGS. 8, 13, 18, and 22. When the thrust reverser 20 is stowed, the inner surface 50 of each blocker door 40 may be aligned with the outer wall 24 of the fan duct 16, while the outer surface 52 may face the cascade elements 26. Additionally, the top edge 58 may be positioned aftward of the bottom edge 60. During deployment of the thrust reverser 20, each blocker door 40 may be rotated such that the bottom edge 60 of each blocker door 40 is pushed inward. The outer surface 52 of each blocker door 40 may face generally forward to receive airflow and redirect it through the cascade elements 26.

The blocker doors 40 may further include mating features 62 that allow the blocker doors 40 to couple to one another in order to reduce air flow through or between the sides of the blocker doors 40 and increase the amount of air that is redirected through the cascade elements 26 during thrust reverser 20 deployment. For example, the first side 54 of one blocker door 40 may couple to the second side 56 of an adjacent blocker door 40. The mating features 62 may integrate with one another such that at least a portion of one blocker door 40 may cover or fit within at least a portion of the adjacent blocker door 40.

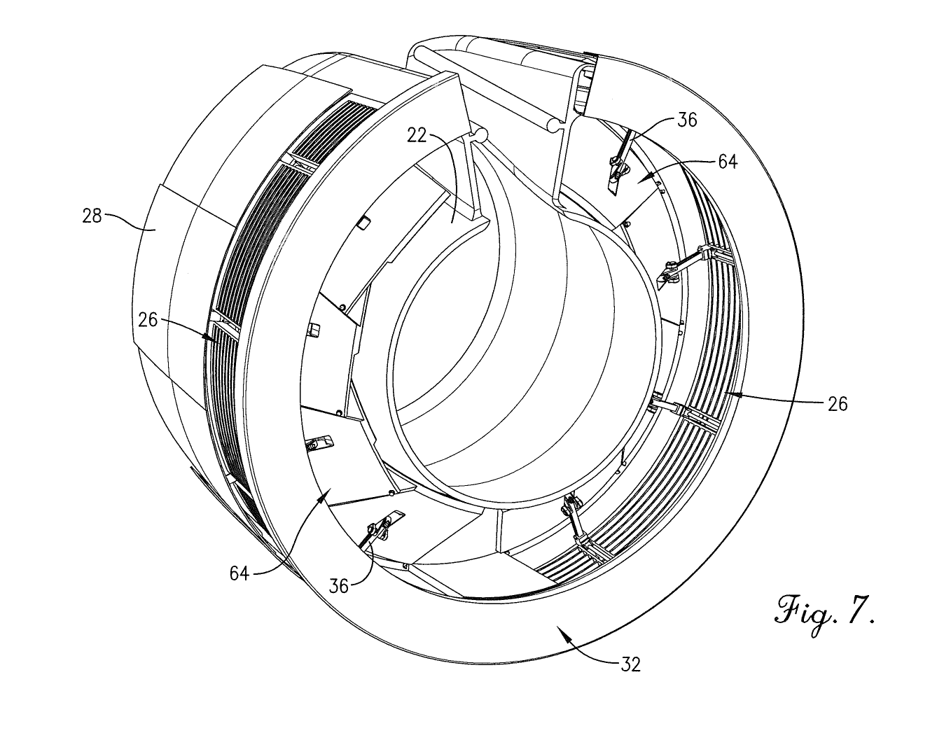

In a first embodiment of the blocker doors 64, as seen in FIGS. 7-10, each blocker door 64 may include an inner flange 66 on the first side 54 and an outer flange 68 on the second side 56. The inner flanges 66 may have a complementary and reciprocal shape to the outer flanges 68. Generally, the inner flange 66 on the first side of one blocker door 64 overlaps the outer flange 68 on the second side 56 of an adjacent blocker door 40. When the blocker doors 40 are deployed, the blocker doors 64 are at maximum overlap such that the inner flanges 66 overlap the outer flanges 68 nearly completely, as seen in FIGS. 7-8.

The linking element 42 generally links the blocker doors 64 together to prevent the one blocker door 64 from decoupling from the adjacent blocker door 64, and guides the motion of the blocker doors 64 relative to one another during deployment of the thrust reverser 20. A first embodiment of the linking element 70 may include a cylindrical slider 72 and an attach pin 74 positioned thereto perpendicularly, as seen in FIG. 11. The slider 72 may fit and slide within an elongated track 76 that is located in proximity to the bottom edge 60 of the outer flange 68 of one blocker door 64. The attach pin 74 may rotatably couple to a receptacle 78 on the inner flange 66 of an adjacent blocker door 64. The linking element 70 may move within the track 76 in the outer flange 68 as the two blocker doors 64 move relative to one another.

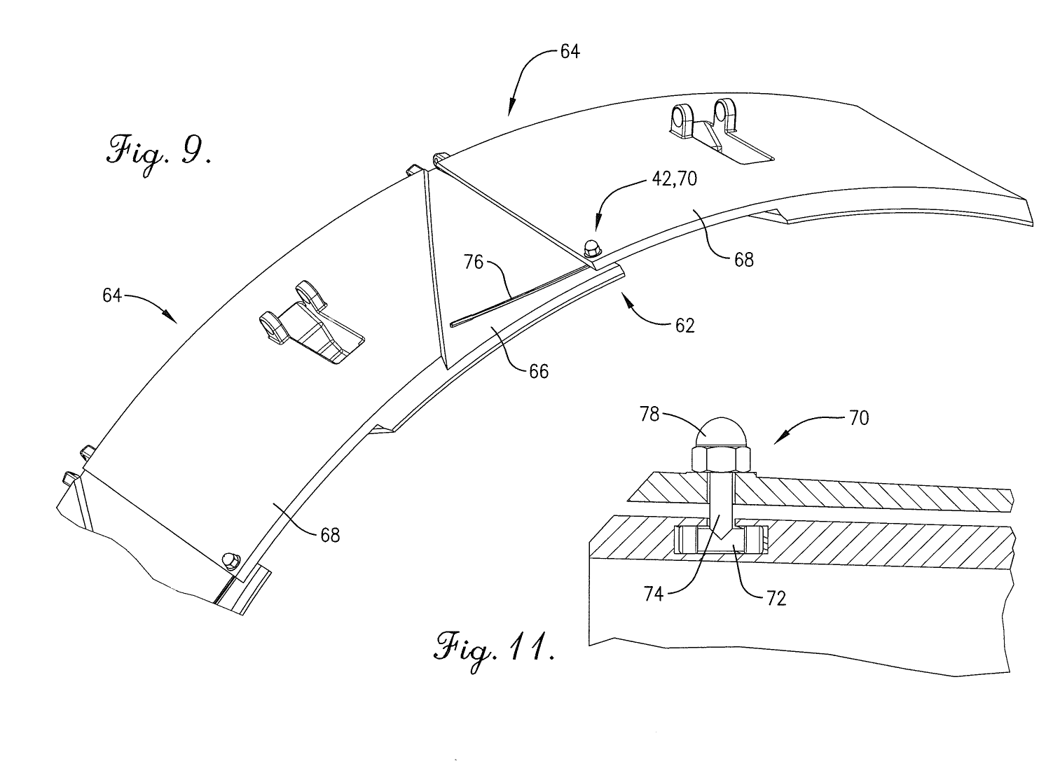

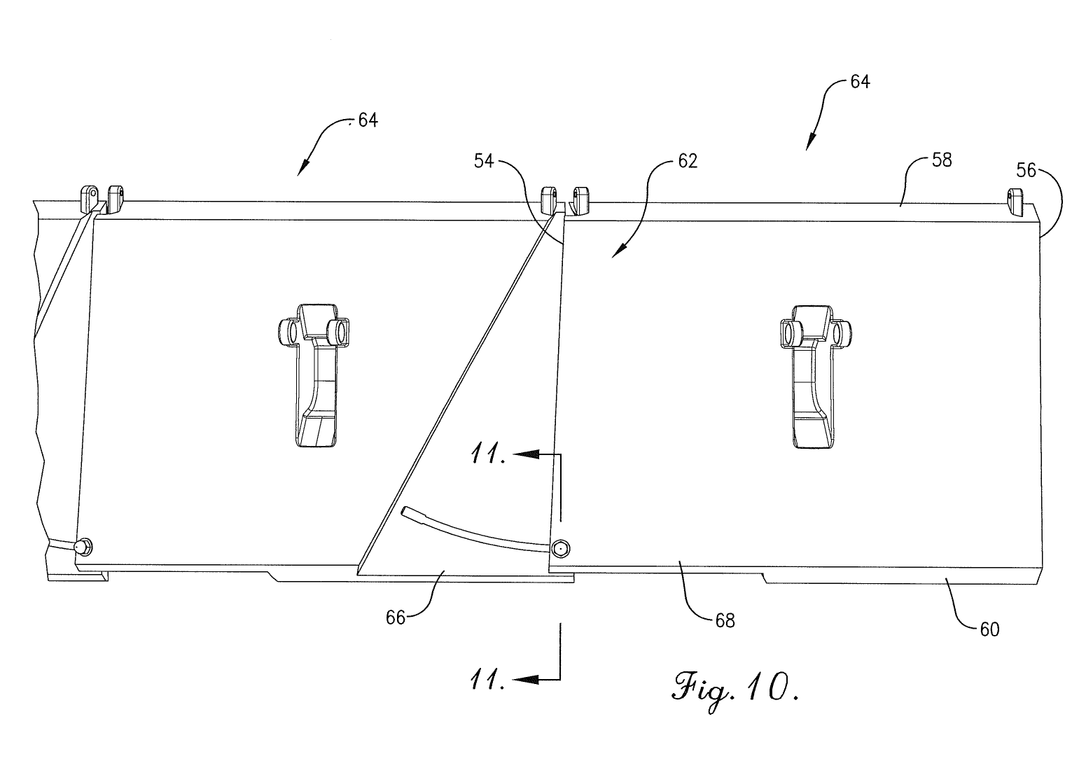

When the blocker doors 64 of the first embodiment are stowed, the blocker doors 64 are positioned in line with the outer wall 24 of the fan duct 16 and the blocker doors 64, while still linked together, are diverged or spread apart. The blocker doors 64 are at minimum overlap such that the inner flanges 66 of one blocker door 64 overlap the outer flanges 68 of an adjacent blocker door 64 slightly, as seen in FIGS. 9-10. When the thrust reverser 20 is deployed, the blocker doors 64 are rotated inward and the bottom edges 60 of the blocker doors 64 converge with the 72 of each blocker door 64 sliding within the tracks 76. The blocker doors 64 are at maximum overlap such that the inner flanges 66 of one blocker door 64 overlap the outer flanges 68 of an adjacent blocker door 64 nearly completely, as seen in FIGS. 7-8.

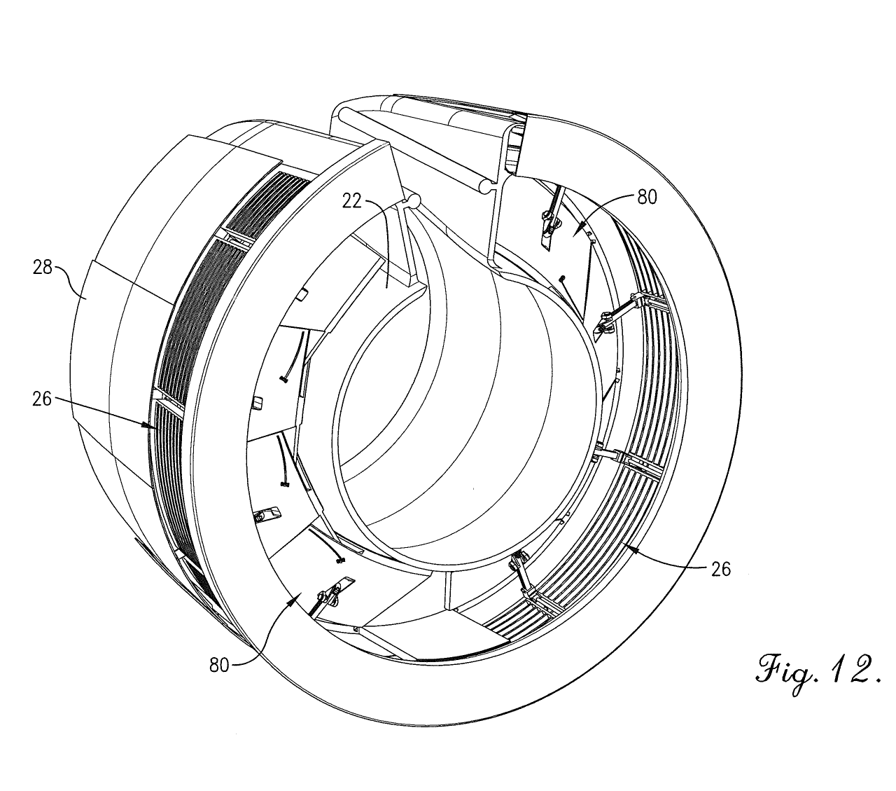

In a second embodiment of the blocker door 80, the first side 54 of one blocker door 80 may interleave with the second side 56 of an adjacent blocker door 80, as seen in FIGS. 12-15. The mating features 62 of the blocker door 80 may include a tongue 82 extending along the center of the length of the first side 54, and a groove 84, complementary to the tongue 82, formed by an upper tab 86 and a spaced-apart lower tab 88 extending along the center of the length of the second side 56. The tongue 82, the upper tab 86, the lower tab 88, and by extension the groove 84 all increase in width from the top edge 58 to the bottom edge 60. Each blocker door 80 may include a tongue 82 on the first side 54 and a groove 84 on the second side 56, such that the tongue 82 of one blocker door 80 fits into the groove 84 of the adjacent blocker door 80.

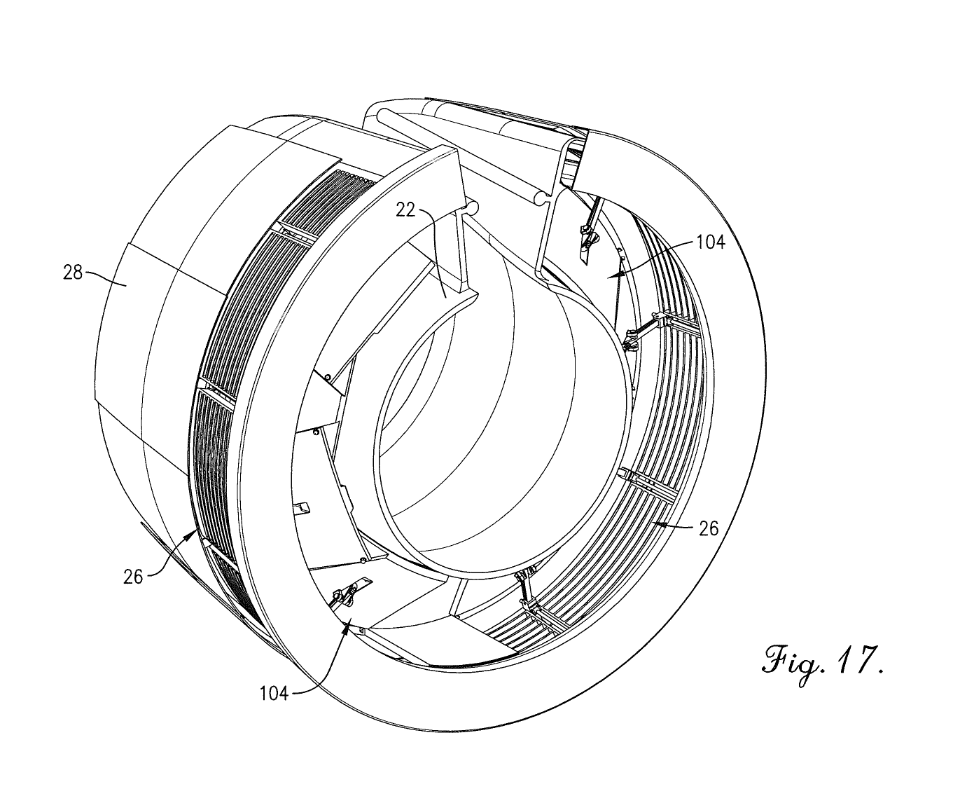

A second embodiment of the linking element 90 may include a threaded fastener 92, a horizontal roller 94, and a vertical roller 96, as seen in FIG. 16. The threaded fastener 92, such as a screw, may be elongated and may fit through an opening near the bottom edge 60 of the tongue 82 as well as an upper track 98 in the upper tab 86 and a lower track 100 in the lower tab 88 near the bottom edge 60. The horizontal roller 94 may be roughly disc-shaped with an opening through which the threaded fastener 92 is positioned and may slide within the lower track 100. The vertical roller 96 may include wheels 102 at opposing ends of the vertical roller 96 and a central opening through which the threaded fastener 92 is positioned. The wheels 102 may roll on the outer surface 52 of the upper tab 86.

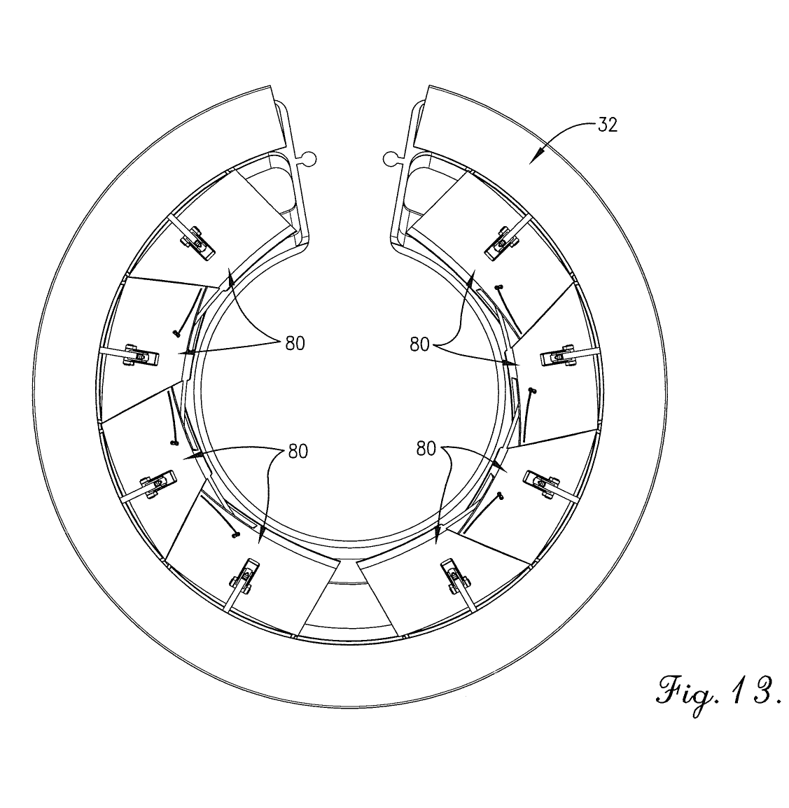

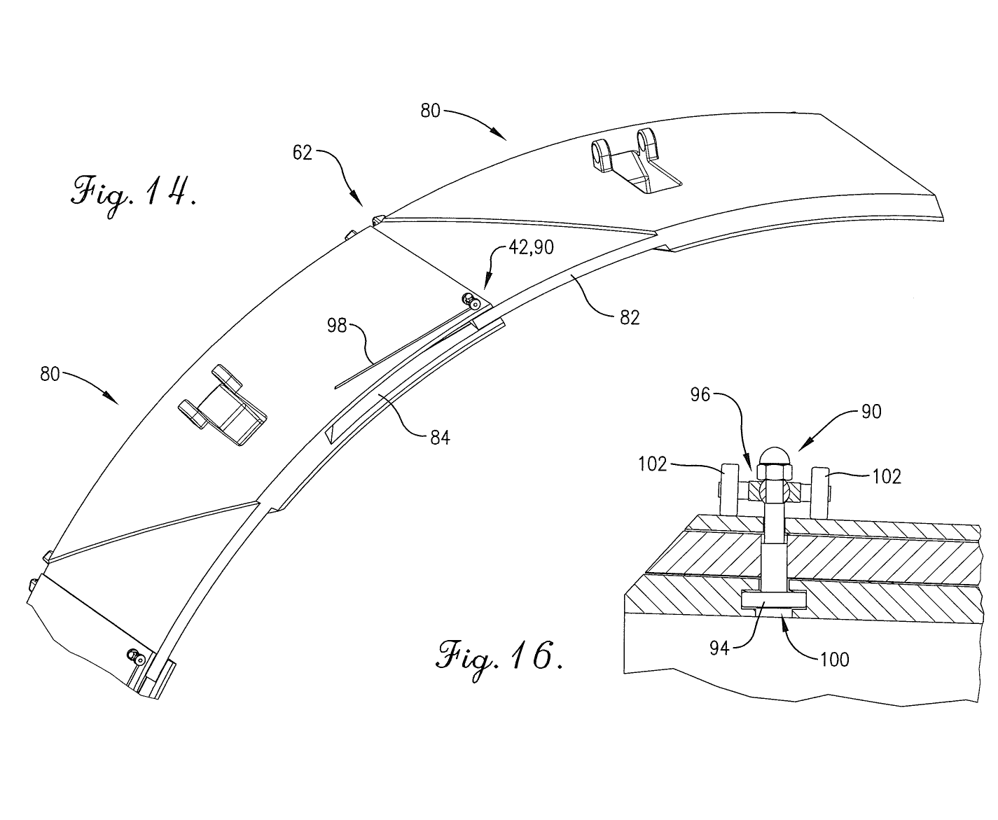

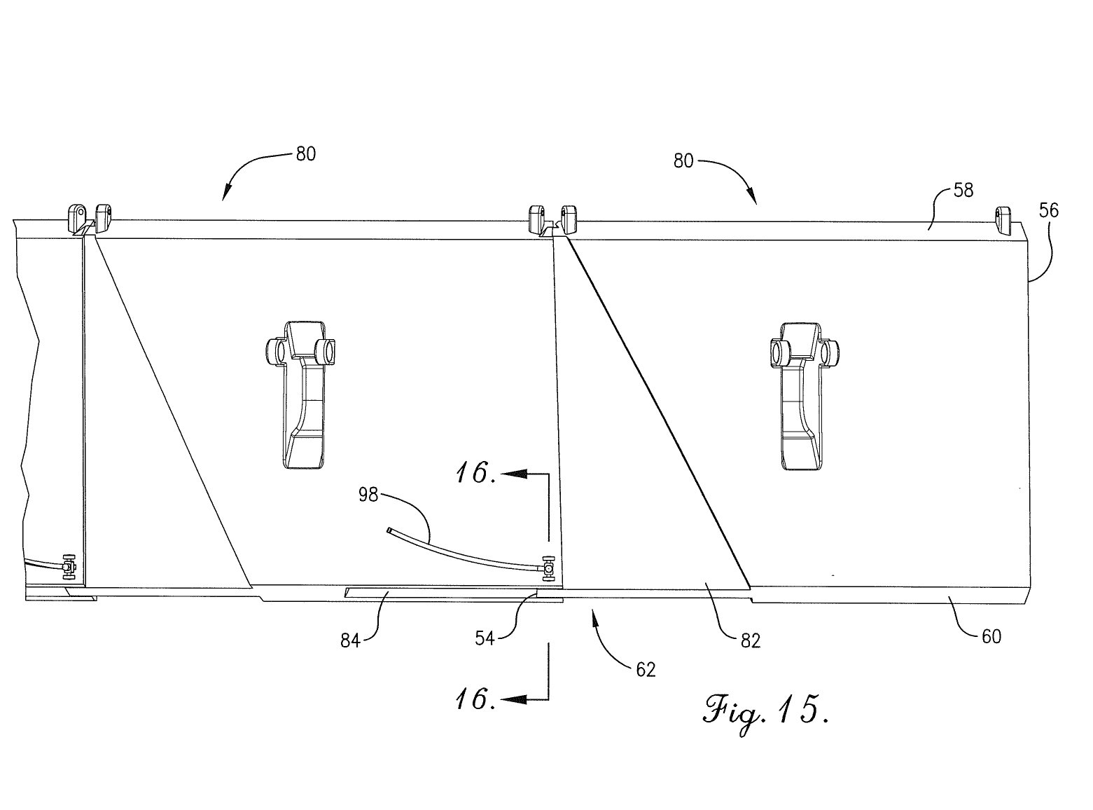

When the blocker doors 80 of the second embodiment are stowed, the blocker doors 80 are positioned in line with the outer wall 24 of the fan duct 16 and the blocker doors 80, while still linked together, are slightly diverged. The blocker doors 80 may be at minimum interleave such that the tongue 82 of one blocker door 80 is slightly within the groove 84 of the adjacent blocker door 80, as shown in FIGS. 14-15. When the thrust reverser 20 is deployed, the blocker doors 80 are rotated inward and the bottom edges 60 of the blocker doors 80 converge with the threaded fastener 92 of each blocker door 80 moving within the upper track 98 and the lower track 100. The blocker doors 80 may be at maximum interleave such that the tongue 82 of one blocker door 80 is mostly within the groove 84 of the adjacent blocker door 80, as shown in FIGS. 12-13.

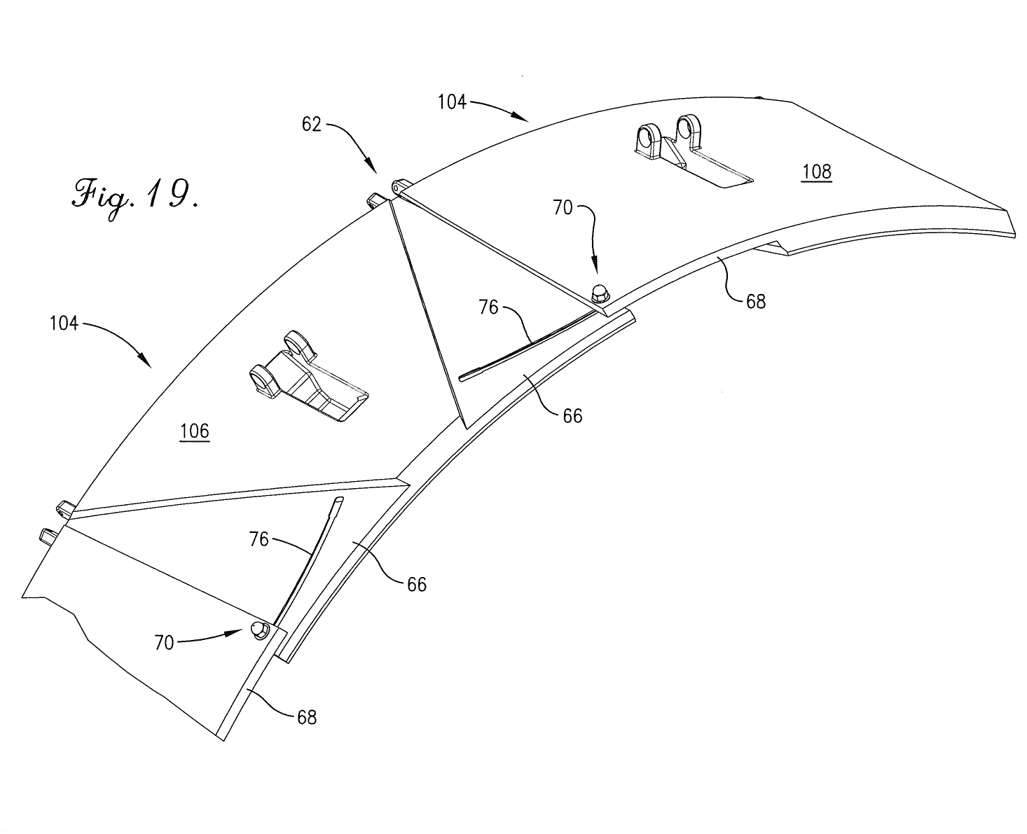

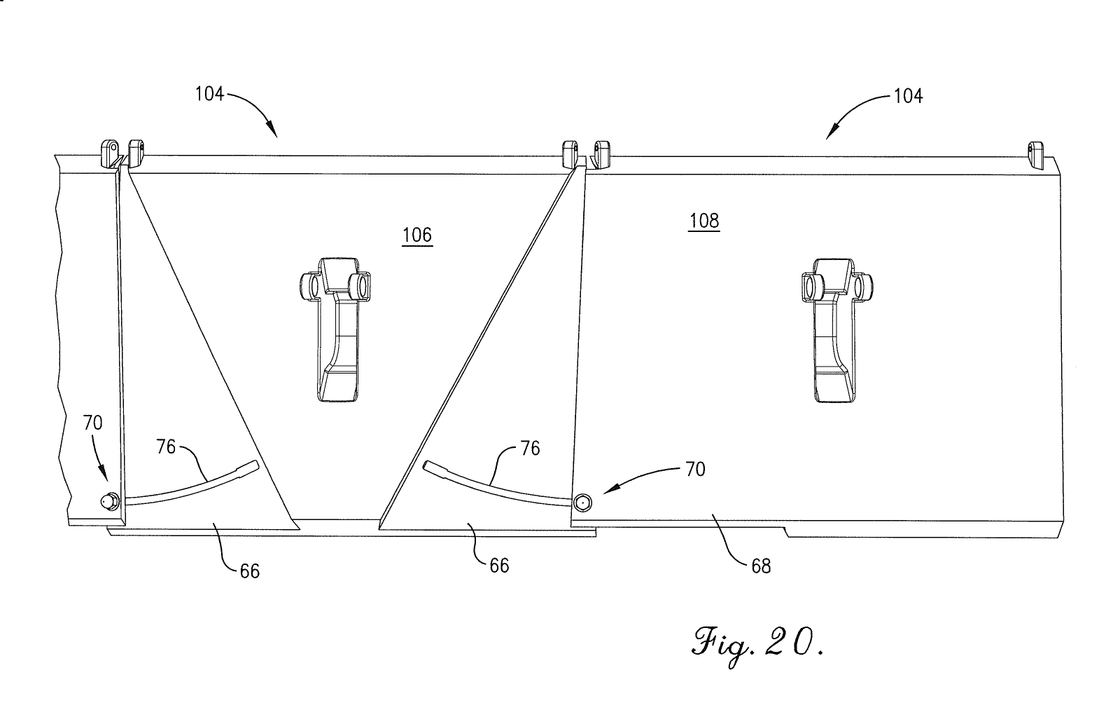

A third embodiment of the blocker door 104, shown in FIGS. 17-20, is substantially similar to the first embodiment of the blocker door 64, except that a first type of blocker door 106 includes inner flanges 66 on both the first side 54 and the second side 56 of the blocker door 106. A second type of blocker door 108 includes outer flanges 68 on both the first side 54 and the second side 56 of the blocker door 108. The first type of blocker door 106 also includes the first embodiment of the linking element 70 on both the first side 54 and the second side 56 of the blocker door 106. The third embodiment of the blocker doors 104 function in a similar fashion to the first embodiment of the blocker doors 64.

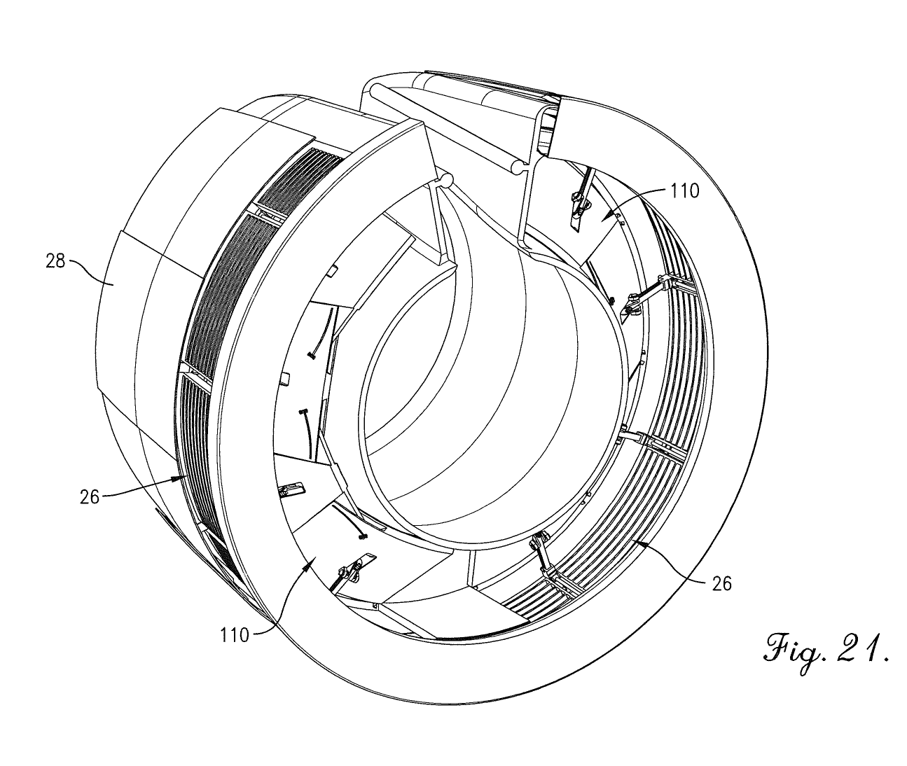

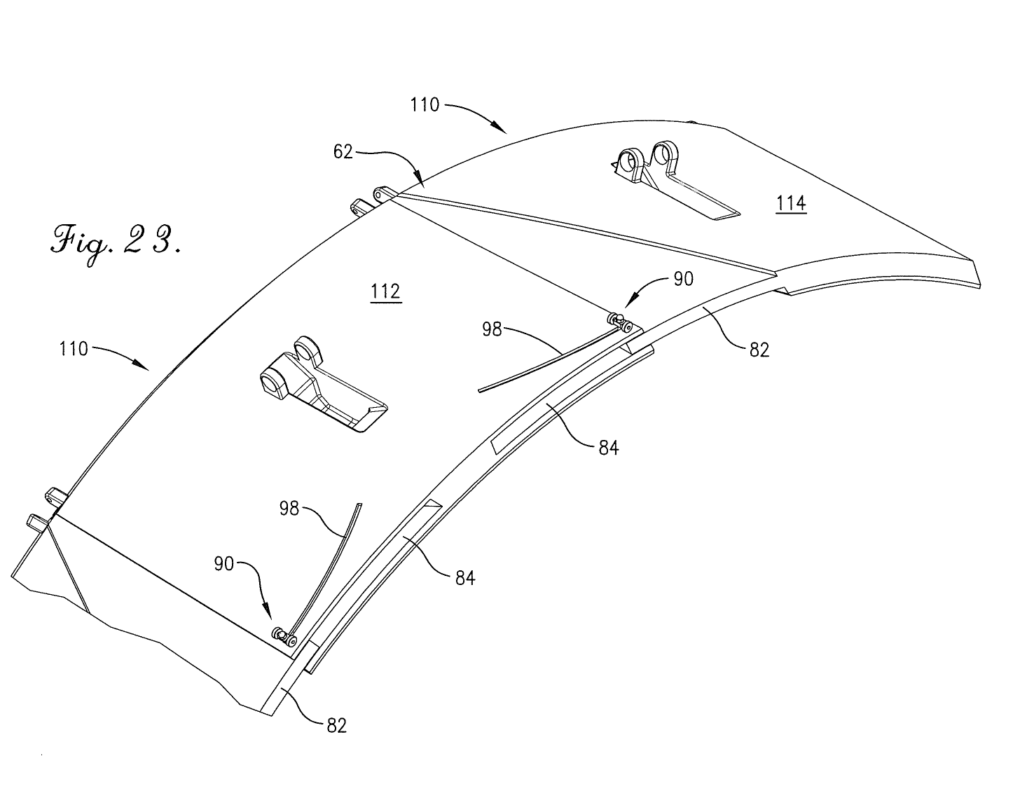

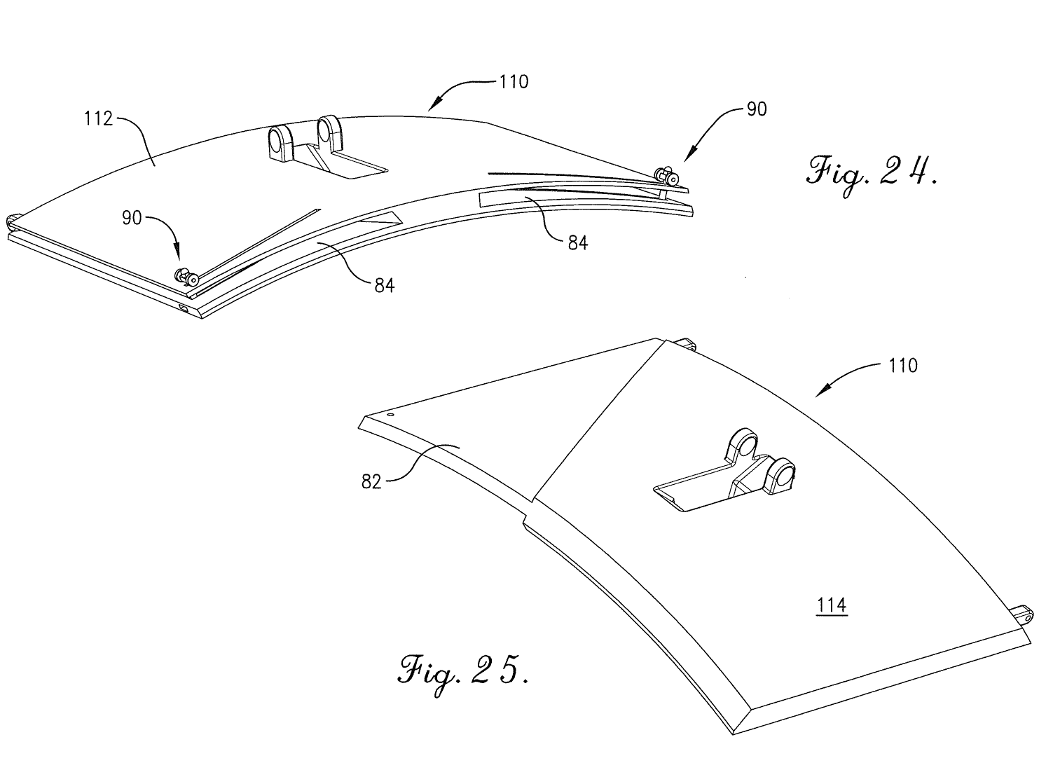

A fourth embodiment of the blocker door 110, shown in FIGS. 21-25, is substantially similar to the second embodiment of the blocker door 80, except that a first type of blocker door 112 includes the groove 84 on both the first side 54 and the second side 56 of the blocker door 112. A second type of blocker door 114 includes the tongue 82 on both the first side 54 and the second side 56 of the blocker door 114. The first type of blocker door 112 also includes the second embodiment of the linking element 90 on both the first side 54 and the second side 56 of the blocker door 112. The fourth embodiment of the blocker doors 110 function in a similar fashion to the second embodiment of the blocker doors 80.

The blocker door system 32 may operate as follows. When the thrust reverser 20 is stowed, the blocker doors 40 may be positioned in line with the outer wall 24 of the fan duct 16 such that air that bypasses the turbine element 18 passes through the fan duct 16 to provide at least a portion of the forward thrust. The blocker doors 40 may be slightly diverged with respect to one another, wherein the blocker doors 40 of the first embodiment and the third embodiment may be at minimum overlap with one another and the blocker doors 40 of the second embodiment and the fourth embodiment may be at minimum interleave with one another. The actuator arms 48 may be retracted into the actuators. Accordingly, the push ring 34 and the crankshafts 38 may be in their forwardmost positions.

When the thrust reverser 20 is deployed, the actuating units 30 may receive a signal to extend the actuator arms 48 aftward, which in turn translates the push ring 34 aftward as well. The connecting rods 36 are all pushed aftward which forces a rotation of the crankshafts 38 and the blocker doors 40. The bottom edges 60 of the blocker doors 40 are rotated inward across the fan duct 16 until the bottom edges 60 contact the inner wall 22 of the fan duct 16 and the outer surface 52 of each blocker door 40 faces generally forward.

During the rotation, the first side 54 of each blocker door 40 converges with the second side 56 of the adjacent blocker door 40. When the bottom edges 60 of the blocker doors 40 contact the inner wall 22 of the fan duct 16, the blocker doors 40 of the first embodiment and the third embodiment may be at maximum overlap with one another and the blocker doors 40 of the second embodiment and the fourth embodiment may be at maximum interleave with one another. The blocker doors 40 form a tight seal with one another to maximize the amount of airflow that is redirected from the fan duct 16 and through the cascade elements 26 while minimizing the amount of airflow that leaks through the blocker doors 40.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A blocker door to be used with an aircraft engine thrust reverser, the blocker door comprising:
a top edge;
a bottom edge opposing the top edge;
a first side extending between the top edge and the bottom edge and including a first mating feature; and
a second side spaced apart from the first side and including a second mating feature that is complementary to the first mating feature such that the first mating feature of a first blocker door integrates with the second mating feature of a second blocker door.

2. The blocker door of claim 1, wherein the first mating feature includes an inner flange and the second mating feature includes an outer flange reciprocal to the inner flange such that the inner flange is operable to overlap the outer flange.

3. The blocker door of claim 1, wherein the first mating feature includes a tongue and the second mating feature includes a groove complementary to the tongue such that the tongue is operable to fit within the groove.

4. The blocker door of claim 1, further including at least one track positioned proximal to the bottom edge in which an element linking one blocker door to another blocker door slides.

5. A blocker door system to be used with an aircraft engine thrust reverser, the blocker door system comprising:
a push ring encircling the aircraft engine;
a plurality of connecting rods connected along the circumference of the push ring;
a plurality of crankshafts each rotatably coupled to one of the connecting rods;
a plurality of blocker doors rotatably coupled to the crankshafts, the blocker doors positioned adjacent one another around the circumference of the aircraft engine wherein at least a portion of one blocker door covers at least a portion of the adjacent blocker door; and
a plurality of linking elements each connecting one blocker door to the adjacent blocker door and operable to guide the motion of the blocker doors relative to one another.

6. The blocker door system of claim 5, wherein each blocker door further includes:
a top edge,
a bottom edge opposing the top edge,
a first side extending between the top edge and the bottom edge and including a first mating feature, and
a second side spaced apart from the first side and including a second mating feature that is complementary to the first mating feature such that the first mating feature of a first blocker door integrates with the second mating feature of a second blocker door.

7. The blocker door system of claim 6, wherein the first mating feature includes an inner flange and the second mating feature includes an outer flange reciprocal to the inner flange such that the inner flange is operable to overlap the outer flange.

8. The blocker door system of claim 6, wherein the first mating feature includes a tongue and the second mating feature includes a groove complementary to the tongue such that the tongue is operable to fit within the groove.

9. The blocker door system of claim 5, wherein each blocker door further includes at least one track positioned proximal to the bottom edge in which one of the linking elements slides.

10. A thrust reverser to be used with an aircraft engine, the thrust reverser comprising:
a plurality of cascade elements to redirect airflow forward with respect to the engine; and
a blocker door system including a plurality of blocker doors positioned adjacent one another around the circumference of the aircraft engine wherein at least a portion of one blocker door covers at least a portion of the adjacent blocker door, the blocker doors operable to occupy a first position when the thrust reverser is stowed and to converge together to a second position when the thrust reverser is deployed to provide maximum airflow to the cascade elements.

11. The thrust reverser of claim 10, further including a plurality of actuating units coupled to the blocker door system and operable to move the blocker doors from the first position to the second position.

12. The thrust reverser of claim 10, wherein the blocker door system further includes:
a push ring encircling the aircraft engine,
a plurality of connecting rods connected along the circumference of the push ring,
a plurality of crankshafts each rotatably coupled to one of the connecting rods, and
a plurality of linking elements each connecting one blocker door to the adjacent blocker door and operable to guide the motion of the blocker doors relative to one another.

13. The thrust reverser of claim 10, wherein each blocker door further includes:
a top edge,
a bottom edge opposing the top edge,
a first side extending between the top edge and the bottom edge and including a first mating feature, and
a second side spaced apart from the first side and including a second mating feature that is complementary to the first mating feature such that the first mating feature of a first blocker door integrates with the second mating feature of a second blocker door.

14. The blocker door system of claim 13, wherein the first mating feature includes an inner flange and the second mating feature includes an outer flange reciprocal to the inner flange such that the inner flange is operable to overlap the outer flange.

15. The blocker door system of claim 13, wherein the first mating feature includes a tongue and the second mating feature includes a groove complementary to the tongue such that the tongue is operable to fit within the groove.

16. The blocker door system of claim 10, wherein each blocker door further includes at least one track positioned proximal to the bottom edge in which one of the linking elements slides.
